(19) United States
(12) Patent Application Publication
(10) Pub. No.: US 2004/0148170 A1
(43) Pub. Date: Jul. 29, 2004

(54) Statistical classifiers for spoken language understanding and command/control scenarios

(76) Inventors: Alejandro Acero, Bellevue, WA (US); Ciprian Chelba, Seattle, WA (US); YeYi Wang, Redmond, WA (US); Leon Wong, Redmond, WA (US); Ravi Shahani, Redmond, WA (US); Michael Calcagno, Kirkland, WA (US); Domenic Cipollone, Redmond, WA (US); Curtis Huttenhower, Pittsburgh, PA (US)

Correspondence Address: Steven M. Koehler, WESTMAN CHAMPLIN & KELLY, International Centre - Suite 1600, 900 South Second Avenue, Minneapolis, MN, 55402-3319, US

(21) Appl. No.: 10/449,708

(22) Filed: May 30, 2003

Related U.S. Application Data
(63) Continuation-in-part of application No. 10/350,199, filed on Jan. 23, 2003.

(51) Int. Cl. G10L 15/18

(52) U.S. Cl. 704/257

(57) ABSTRACT

The present invention involves using one or more statistical classifiers in order to perform task classification on natural language inputs. In another embodiment, the statistical classifiers can be used in conjunction with a rule-based classifier to perform task classification. In one application, a statistical classifier is used in order ascertain if an input is a search query or a natural-language input.

### CROSS-REFERENCE TO RELATED APPLICATION

The present invention is a continuation-in-part and claims priority of U.S. Patent Application SYSTEM OF USING STATISTICAL CLASSIFIERS FOR SPOKEN LANGUAGE UNDERSTANDING, having Ser. No. 10/350,199 and filed Jan. 23, 2003.

### BACKGROUND OF THE INVENTION

The present invention relates to processing input interpreting natural language input provided from a user to a computer system. More specifically, the present invention relates to use of a statistical classifier for processing such commands.

It is becoming more desirable to incorporate a natural-language interface in a computer system and/or applications that allow a user to provide a information without conforming to a specific structure for parameters that may be needed in order to process the command. A natural-language processing system that underlies the natural-language interface must be robust with respect to linguistic and conceptual variation and should be able to accommodate other forms of ambiguities such as modifier attachment ambiguities, quantifier scope ambiguities, conjunction and disjunction ambiguities, nominal compound ambiguities, etc.

However, with the advance of more powerful processing computing machines, larger storage capacities and the ability to connect the computer to other computers in a local area network or a wide area network such as the Internet, the variety of commands that can be provided by the user are ever increasing. For instance, in one application, it is desirable to allow a user to input a natural-language command, for example, to send an e-mail, to create a photo album, etc., while also allowing the user to input a search query that can be used to obtain relevant information for the user from the Internet. In such a situation, it would be desirable for the processing system be able to distinguish input from the user that is related to a search from input that is related to a natural-language command.

Although some natural-language commands provided by the user may be readily recognized due to the direct nature of the command such as “send e-mail to Jennifer with artwork”, difficulties arise when the user's input is not as direct, but rather, more cryptic such as “art to Jennifer”, the latter being a command to e-mail Jennifer an artwork file. In such a case, it would be an error to invoke a search for information on the Internet related to “art” and “Jennifer”.

The foregoing is one example of the ambiguity that can arise when processing natural-language command for applications. There is thus an ever-continuing need for improvements in natural-language processing so that the user can provide commands in the most convenient format, while still having the system properly ascertain the user's intent.

### SUMMARY OF THE INVENTION

Natural user interfaces which can accept natural language inputs may need two levels of understanding of the input in order to complete an action (or task) based on the input. First, the system may classify the user input to one of a number of different classes or tasks. This involves first generating a list of tasks which the user can request and then classifying the user input to one of those different tasks.

Next, the system may identify semantic items in the natural language input. The semantic items correspond to the specifics of a desired task.

By way of example, if the user typed in a statement “Send an email to John Doe.” Task classification would involve identifying the task associated with this input as a “SendMail” task and the semantic analysis would involve identifying the term “John Doe” as the “recipient” of the electronic mail message to be generated.

Statistical classifiers are generally considered to be robust and can be easily trained. Also, such classifiers require little supervision during training, but they often suffer from poor generalization when data is insufficient. Grammar-based robust parsers are expressive and portable, and can model the language in granularity. These parsers are easy to modify by hand in order to adapt to new language usages. While robust parsers yield an accurate and detailed analysis when a spoken utterance is covered by the grammar, they are less robust for those sentences not covered by the training data, even with robust understanding techniques.

One embodiment of the present invention involves using one or more statistical classifiers in order to perform task classification on natural language inputs.

In one embodiment, the statistical classifier is configured to form tokens of a textual input and access a lexicon to ascertain token frequency of each token corresponding to the textual input in order to identify a target class. The lexicon stores the frequency of tokens appearing in training data for a plurality of examples indicative of each class. The statistical classifier can calculate a probability that the textual input corresponds to each of a plurality of possible classes based on token frequency of each token corresponding to the textual input.

In another embodiment, the statistical classifiers can be used in conjunction with a rule-based classifier to perform task classification. In particular, while an improvement in task classification itself is helpful and addresses the first level of understanding that a natural language interface must demonstrate, task classification alone may not provide the detailed understanding of the semantics required to complete some tasks based on a natural language input. Therefore, another embodiment of the present invention includes a semantic analysis component as well. This embodiment of the invention uses a rule-based understanding system to obtain a deep understanding of the natural language input. Thus, the invention can include a two pass approach in which classifiers are used to classify the natural language input into one or more tasks and then rule-based parsers are used to fill semantic slots in the identified tasks.

In one task classification application, which also comprises another aspect of the present invention, the statistical classifier can be used to ascertain if the textual input comprises a search query or a natural language command. If it determined that the textual input comprises a search query, the textual input can be forwarded to a service to perform the search. In addition, or in the alternative, the statistical classifier can determine that the textual input can be a natural-language command. If the statistical classifier has not already ascertained a target class corresponding to a natural-language command, the textual input can be further processed using a second statistical classifier for this purpose.

An interpretation, or a list of interpretations, can be provided as an output from statistical processing in a format that can readily forwarded to an application for processing in order to perform the action intended. As another aspect of the present invention, the interpretations provided by statistical processing can be combined with interpretations provided from another form of processing of the textual input such as semantic analysis to form a combined list that can be rendered to the user in order to select the correct interpretation. In one embodiment, the interpretations from both forms of analysis are in the same format in order that the interpretations can be readily combined, allowing duplicates to be removed, and if desired, less specific interpretations to also be removed.

### BRIEF DESCRIPTION OF THE DRAWINGS

FIG. 1 is a block diagram of one illustrative environment in which the present invention can be used.

FIG. 2 is a block diagram of a portion of a natural language interface in accordance with one embodiment of the present invention.

FIG. 3 illustrates another embodiment in which multiple statistical classifiers are used.

FIG. 4 illustrates another embodiment in which multiple, cascaded statistical classifiers are used.

FIG. 5 is a block diagram illustrating another embodiment in which not only one or more statistical classifiers are used for task classification, and a rule-based analyzer is also used for task classification.

FIG. 6 is a block diagram of a portion of a natural language interface in which task classification and more detailed semantic understanding are obtained in accordance with one embodiment of the present invention.

FIG. 7 is a flow diagram illustrating the operation of the system shown in FIG. 6.

FIG. 8 is a schematic block diagram of a system for processing input that can include natural-language commands.

FIG. 9 is a block a diagram of an alternative computing environment in which the present invention may be practiced.

FIG. 10 is a flow chart illustrating a method for creating a lexicon.

FIG. 11 is a flow chart illustrating a method for analyzing input from a user.

FIG. 12 is a pictorial representation of a plurality of probability arrays.

FIG. 113 is a block diagram of components within a semantic analysis engine.

FIG. 14 is a block diagram of an example of an application schema.

### DETAILED DESCRIPTION OF ILLUSTRATIVE EMBODIMENTS

### Overview

Aspects of the present invention involve performing task classification on a natural language input and performing semantic analysis on a natural language input in conjunction with task classification in order to obtain a natural user interface. However, prior to discussing the invention in more detail, one embodiment of an exemplary environment in which the present invention can be implemented will be discussed.

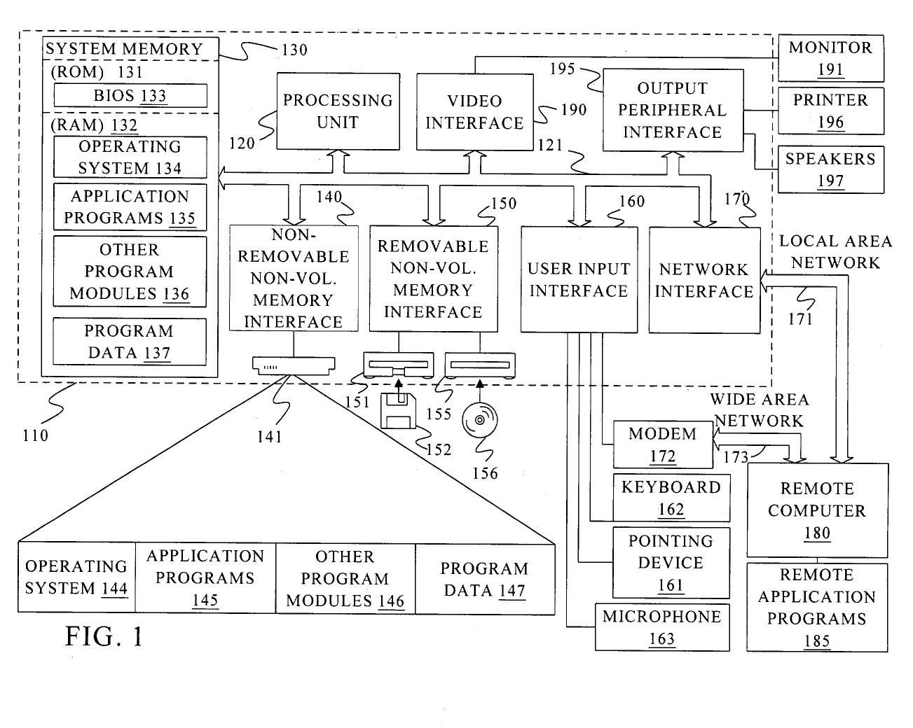

FIG. 1 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Tasks performed by the programs and modules are described below and with the aid of figures. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

### Overview of Task Classification System

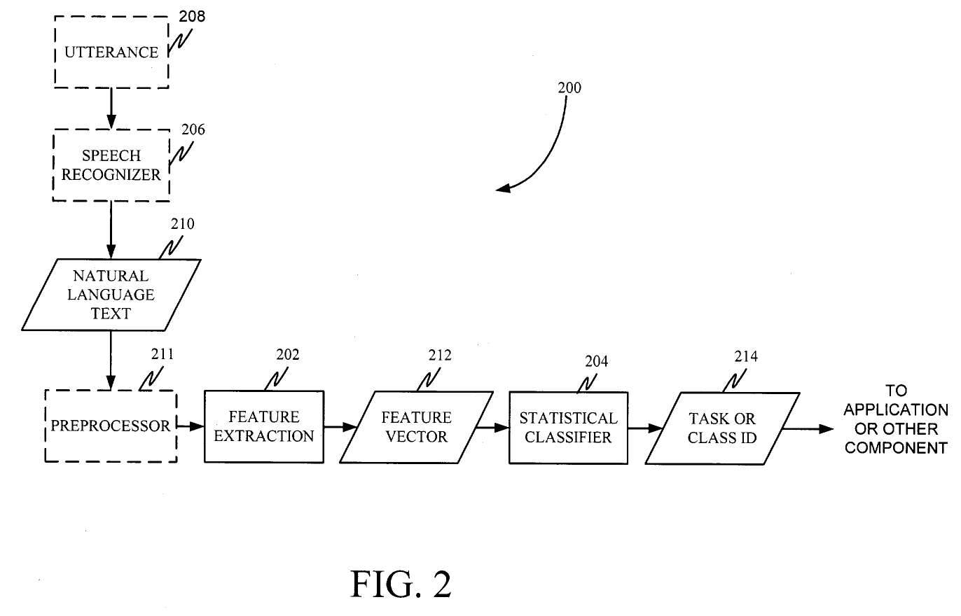

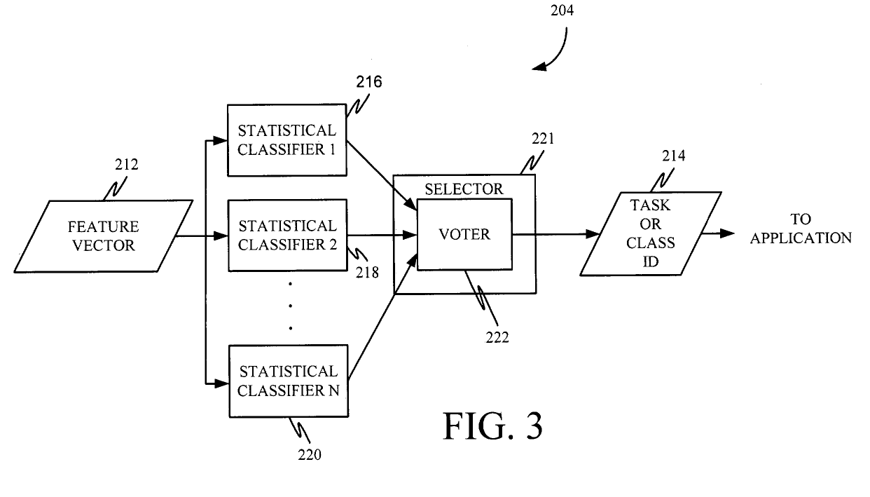

FIG. 2 is a block diagram of a portion of a natural language interface 200. System 200 includes a feature selection component 202 and a statistical classifier 204. System 200 can also include optional speech recognition engine 206 and optional preprocessor 211. Where interface 200 is to accept speech signals as an input, it includes speech recognizer 206. However, where interface 200 is simply to receive textual input, speech recognizer 206 is not needed. Also, preprocessing (as discussed below) is optional. The present discussion will proceed with respect to an embodiment in which speech recognizer 206 and preprocessor 211 are present, although it will be appreciated that they need not be present in other embodiments. Also, other natural language communication modes can be used, such as handwriting or other modes. In such cases, suitable recognition components, such as handwriting recognition components, are used.

In order to perform task classification, system 200 first receives an utterance 208 in the form of a speech signal that represents natural language speech spoken by a user. Speech recognizer 206 performs speech recognition on utterance 208 and provides, at its output, natural language text 210. Text 210 is a textual representation of the natural language utterance 208 received by speech recognizer 206. Speech recognizer 206 can be any known speech recognition system which performs speech recognition on a speech input. Speech recognizer 206 may include an application-specific dictation language model, but the particular way in which speech recognizer 206 recognizes speech does not form any part of the invention. Similarly, in another embodiment, speech recognizer 206 outputs a list of results or interpretations with respective probabilities. Later components operate on each interpretation and use the associated probabilities in task classification.

Natural language text 210 can optionally be provided to preprocessor 211 for preprocessing and then to feature selection component 202. Preprocessing is discussed below with respect to feature selection. Feature selection component 202 identifies features in natural language text 210 (or in each text 210 in the list of results output by the speech recognizer) and outputs feature vector 212 based upon the features identified in text 210. Feature selection component 202 is discussed in greater detail below. Briefly, feature selection component 202 identifies features in text 210 that can be used by statistical classifier 204.

Statistical classifier 204 receives feature vector 212 and classifies the feature vector into one or more of a plurality of predefined classes or tasks. Statistical classifier 202 outputs a task or class identifier 214 identifying the particular task or class to which statistical classifier 204 has assigned feature vector 212. This, of course, also corresponds to the particular class or task to which the natural language input (utterance 208 or natural language text 210) corresponds. Statistical classifier 204 can alternatively output a ranked list (or n-best list) of task or class identifiers 214. Statistical classifier 204 will also be described in greater detail below. The task identifier 214 is provided to an application or other component that can take action based on the identified task. For example, if the identified task is to SendMail, identifier 214 is sent to the electronic mail application which can, in turn, display an electronic mail template for use by the user of course, any other task or class is contemplated as well. Similarly, if an n-best list of identifiers 214 is output, each item in the list can be displayed through a suitable user interface such that a user can select the desired class or task.

It can thus be seen that system 200 can perform at least the first level of understanding required by a natural language interface—that is, identifying a task represented by the natural language input.

### Feature Selection

A set of features must be selected for extraction from the natural language input. The set of features will illustratively be those found to be most helpful in performing task classification. This can be empirically, or otherwise, determined.

In one embodiment, the natural language input text 210 is embodied as a set of words. One group of features will illustratively correspond to the presence or absence of words in the natural language input text 210, wherein only words in a certain vocabulary designed for a specific application are considered, and words outside the vocabulary are mapped to a distinguished word-type such as <UNKNOWN>. Therefore, for example, a place will exist in feature vector 212 for each word in the vocabulary (including the <UNKNOWN> word), and its place will be filled with a value of 1 or 0 depending upon whether the word is present or not in the natural language input text 210, respectively. Thus, the binary feature vector would be a vector having a length corresponding to the number of words in the lexicon (or vocabulary) supported by the natural language interface.

Of course, it should be noted that many other features can be selected as well. For example, the co-occurrences of words can be features. This may be used, for instance, in order to more explicitly identify tasks to be performed. For example, the co-occurrence of the words “send mail” may be a feature in the feature vector. If these two words are found, in this order, in the input text, then the corresponding feature in the feature vector is marked to indicate the feature was present in the input text. A wide variety of other features can be selected as well, such as bi-grams, tri-grams, other n-grams, and any other desired features.

Similarly, preprocessing can optionally be performed on natural language text 210 by preprocessor 211 in order to arrive at feature vector 212. For instance, it may be desirable that the feature vector 212 only indicate the presence or absence of words that have been predetermined to carry semantic content. Therefore, natural language text 210 can be preprocessed to remove stop words and to maintain only content words, prior to the feature selection process. Similarly, preprocessor 211 can include rule-based systems (discussed below) that can be used to tag certain semantic items in natural language text 210. For instance, the natural language text 210 can be preprocessed so that proper names are tagged as well as the names of cities, dates, etc. The existence of these tags can be indicated as a feature as well. Therefore, they will be reflected in feature vector 212. In another embodiment, the tagged words can be removed and replaced by the tags.

In addition stemming can also be used in feature selection. Stemming is a process of removing morphological variations in words to obtain their root forms. Examples of morphological variations include inflectional changes (such as pluralization, verb tense, etc.) and derivational changes that alter a word's grammatical role (such as adjective versus adverb as in slow versus slowly, etc.) Stemming can be used to condense multiple features with the same underlying semantics into single features. This can help overcome data sparseness, improve computational efficiency, and reduce the impact of the feature independence assumptions used in statistical classification methods.

In any case, feature vector 212 is illustratively a vector which has a size corresponding to the number of features selected. The state of those features in natural language input text 210 can then be identified by the bit locations corresponding to each feature in feature vector 212. While a number of features have been discussed, this should not be intended to limit the scope of the present invention and different or other features can be used as well.

### Task or Class Identification (Text Classification)

Statistical classifiers are very robust with respect to unseen data. In addition, they require little supervision in training. Therefore one embodiment of the present invention uses statistical classifier 204 to perform task or class identification on the feature vector 212 that corresponds to the natural language input. A wide variety of statistical classifiers can be used as classifier 204, and different combinations can be used as well. The present discussion proceeds with respect to Naive Bayes classifiers, task-dependent n-gram language models, and support vector machines. The present discussion also proceeds with respect to a combination of statistical classifiers, and a combination of statistical classifiers and a rule-based system for task or class identification.

The following description will proceed assuming that the feature vector is represented by w and it has a size V (which is the size of the vocabulary supported by system 200) with binary elements (or features) equal to one if the given word is present in the natural language input and zero otherwise. Of course, where the features include not only the vocabulary or lexicon but also other features (such as those mentioned above with respect to feature selection) the dimension of the feature vector will be different.

The Naive Bayes classifier receives this input vector and assumes independence among the features. Therefore, given input vector w, its target class can be found by choosing the class with the highest posterior probability:

$$\begin{matrix}\hat{c} = {argmax}_{c} P ( c \vert w ) = argmax P ( c ) P ( w \vert c ) \\ = {argmax}_{c} P ( c ) {\prod }_{i = 1}^{V} {P ( {w}_{i} = 1 \vert c )}^{δ ( wi , 1 )} {P ( {w}_{i} = 0 \vert c )}^{δ ( wi , 0 )}\end{matrix} \qquad \text{Eq. 1}$$

Where P (c|w) is the probability of a class given the sentence (represented as the feature vector w);

P(c) is the probability of a class;

P(w|c) is the conditional probability of the feature vector extracted from a sentence given the class c;

P(wi=1|c) or P(wi=0|c) is the conditional probability that word wi is observed or not observed, respectively, in a sentence that belongs to class c;

δ(wi,1)=1, if wi=1 and 0 otherwise; and

δ(wi,0)=1, if wi=0 and 0 otherwise.

In other words, according to Equation 1, the classifier picks the class c that has the greatest probability P(c|w) as the target class for the natural language input. Where more than one target class is to be identified, then the top n probabilities calculated using P(c|w)=P(c)P(w|c) will correspond to the top n classes represented by the natural language input.

Because sparseness of data may be a problem, P(wᵢ|c) can be estimated as follows:

$$P ( {w}_{i} = 1 \vert c ) = \frac{{N}_{c}^{i} + b}{{N}_{c} + 2 b} \qquad \text{Eq. 2}$$

P(wᵢ=0|c)=1=P(wᵢ=1|c) Eq. 3

where N_{c} is the number of natural language inputs for class c in the training data;

N¹_{c} is the number of times word i appeared in the natural language inputs in the training data;

P(wᵢ=1|c) is the conditional probability that the word i appears in the natural language textual input given class c; and

P(wᵢ=0|c) is the conditional probability that the word i does not appear in the input given class c; and

b is estimated as a value to smooth all probabilities and is tuned to maximize the classification accuracy of cross-validation data in order to accommodate unseen data. Of course, it should be noted that b can be made sensitive to different classes as well, but may illustratively simply be maximized in view of cross-validation data and be the same regardless of class.

Also, it should again be noted that when using a Naïve Bayes classifier the feature vector can be different than simply all words in the vocabulary. Instead, preprocessing can be run on the natural language input to remove unwanted words, semantic items can be tagged, bi-grams, tri-grams and other word co-occurrences can be identified and used as features, etc.

Another type of classifier which can be used as classifier 204 is a set of class-dependent n-gram statistical language model classifiers. If the words in the natural language input 210 are viewed as values of a random variable instead of binary features, Equation 1 can be decomposed in a different way as follows:

$$\begin{matrix}\hat{c} = {argmax}_{c} P ( c ) P ( w \vert c ) \\ = {argmax}_{c} P ( c ) {\prod }_{i = 1}^{\vert w \vert} P ( {w}_{i} \vert c , {w}_{i - 1} , {w}_{i - 2 , … , {w}_{1}} )\end{matrix} \qquad \text{Eq. 4}$$

where |w| is the length of the text w, and Markov independence assumptions of orders 1, 2 and 3 can be made to use a task-specific uni-gram P(wᵢ|c), bi-gram P(wᵢ|c,wᵢ−1) or tri-gram P(wᵢ|c, wᵢ−1, wᵢ−2), respectively.

One class-specific model is generated for each class c. Therefore, when a natural language input 210 is received, the class-specific language models P(w|c) are run on the natural language input 210, for each class. The output from each language model is multiplied by the prior probability for the respective class. The class with the highest resulting value corresponds to the target class.

While this may appear to be highly similar to the Naive Bayes classifier discussed above, it is different. For example, when considering n-grams, word co-occurrences of a higher order are typically considered than when using the Naive Bayes classifier. For example, tri-grams require looking at word triplets whereas, in the Naive Bayes classifier, this is not necessarily the case.

Similarly, even if only uni-grams are used, in the n-gram classifier, it is still different than the Naive Bayes classifier. In the Naive Bayes Classifier, if a word in the vocabulary occurs in the natural language input 210, the feature value for that word is a 1, regardless of whether the word occurs in the input multiple times. By contrast, the number of occurrences of the word will be considered in the n-gram classifier.

In accordance with one embodiment, the class-specific n-gram language models are trained by splitting sentences in a training corpus among the various classes for which n-gram language models are being trained. All of the sentences corresponding to each class are used in training an n-gram classifier for that class. This yields a number c of n-gram language models, where c corresponds to the total number of classes to be considered.

Also, in one embodiment, smoothing is performed in training the n-gram language models in order to accommodate for unseen training data. The n-gram probabilities for the class-specific training models are estimated using linear interpolation of relative frequency estimates at different orders (such as 0 for a uniform model . . . , n for a n-gram model). The linear interpolation weights at different orders are bucketed according to context counts and their values are estimated using maximum likelihood techniques on cross-validation data. The n-gram counts from the cross-validation data are then added to the counts gathered from the main training data to enhance the quality of the relative frequency estimates. Such smoothing is set out in greater detail in Jelinek and Mercer, Interpolated Estimation of Markov Source Parameters From Sparse Data, Pattern Recognition in Practice, Gelsema and Kanal editors, North-Holland (1980).

Support vector machines can also be used as statistical classifier 204. Support vector machines learn discriminatively by finding a hyper-surface in the space of possible inputs of feature vectors. The hyper-surface attempts to split the positive examples from the negative examples. The split is chosen to have the largest distance from the hyper-surface to the nearest of the positive and negative examples. This tends to make the classification correct for test data that is near, but not identical to, the training data. In one embodiment, sequential minimal optimization is used as a fast method to train support vector machines.

Again, the feature vector can be any of the feature vectors described above, such as a bit vector of length equal to the vocabulary size where the corresponding bit in the vector is set to one if the word appears in the natural language input, and other bits are set to 0. Of course, the other features can be selected as well and preprocessing can be performed on the natural language input prior to feature vector extraction, as also discussed above. Also, the same techniques discussed above with respect to cross validation data can be used during training to accommodate for data sparseness.

The particular support vector machine techniques used are generally known and do not form part of the present invention. One exemplary support vector machine is described in Burges, C. J. C., A Tutorial on Support Vector Machines for Pattern Recognition, Data Mining and Discovery, 1998, 2(2) pp. 121-167. One technique for performing training of the support vector machines as discussed herein is set out in Platt, J. C., Fast Training of Support Vector Machines Using Sequential Minimal Optimization, Advances in Kernel Methods—Support Vector Learning, B. Scholkopf, C. J. C. Burger, and A. J. Smola, editors, 1999, pp. 185-208.

Another embodiment of statistical classifier 204 is shown in FIG. 3. In the embodiment shown in FIG. 3, statistical classifier component 204 includes a plurality of individual statistical classifiers 216, 218 and 220 and a selector 221 which is comprised of a voting component 222 in FIG. 3. The statistical classifiers 216-220 are different from one another and can be the different classifiers discussed above, or others. Each of these statistical classifiers 216-220 receives feature vector 212. Each classifier also picks a target class (or a group of target classes) which that classifier believes is represented by feature vector 212. Classifiers 216-220 provide their outputs to class selector 221. In the embodiment shown in FIG. 3, selector 221 is a voting component 222 which simply uses a known majority voting technique to output as the task or class ID 214, the ID associated with the task or class most often chosen by statistical classifiers 216-220 as the target class. Other voting techniques can be used as well. For example, when the classifiers 216-220 do not agree with one another, it may be sufficient to choose the output of a most accurate one of the classifiers being used, such as the support vector machine. In this way, the results from the different classifiers 216-220 can be combined for better classification accuracy.

In addition, each of classifiers 216-220 can output a ranked list of target classes (an n-best list). In that case, selector 221 can use the n-best list from each classifier in selecting a target class or its own n-best list of target classes.

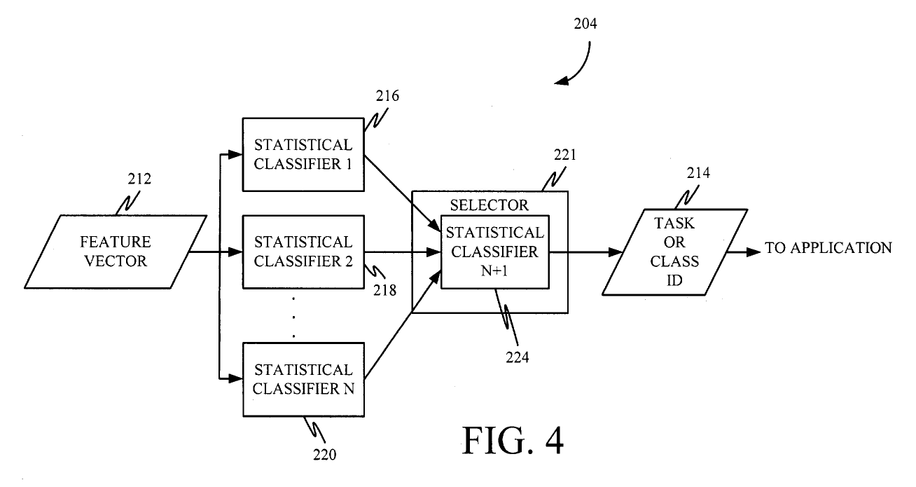

FIG. 4 shows yet another embodiment of statistical classifier 204 shown in FIG. 2. In the embodiment shown in FIG. 4, a number of the items are similar to those shown in FIG. 3, and are similarly numbered. However, selector 221, which was a voting component 222 in the embodiment shown in FIG. 3, is an additional statistical classifier 224 in the embodiment shown in FIG. 4. Statistical classifier 224 is trained to take, as its input feature vector, the outputs from the other statistical classifiers 216-220. Based on this input feature vector, classifier 224 outputs the task or class ID 214. This further improves the accuracy of classification.

It should also be noted, of course, that the selector 221 which ultimately selects the task or class ID could be other components as well, such as a neural network or a component other than the voting component 222 shown in FIG. 3 and the statistical classifier 224 shown in FIG. 4.

In order to train the class or task selector 221 training data is processed. The selector takes as an input feature vector the outputs from the statistical classifiers 216-220 along with the correct class for the supervised training data. In this way, the selector 221 is trained to generate a correct task or class ID based on the input feature vector.

In another embodiment, each of the statistical classifiers 216-220 not only output a target class or a set of classes, but also a corresponding confidence measure or confidence score which indicates the confidence that the particular classifier has in its selected target class or classes. Selector 221 can receive the confidence measure both during training, and during run time, in order to improve the accuracy with which it identifies the task or class corresponding to feature vector 212.

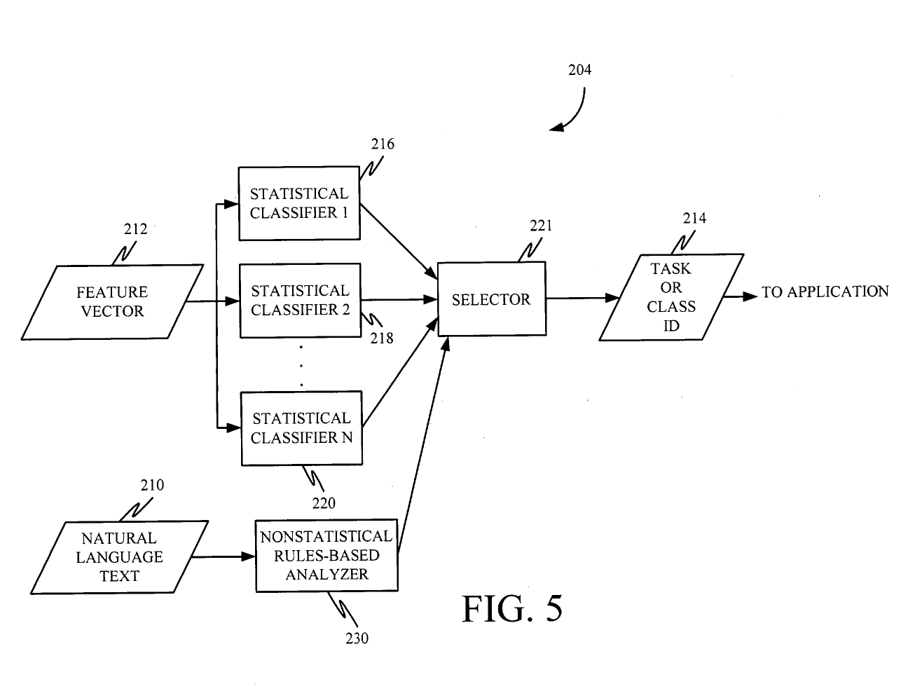

FIG. 5 illustrates yet another embodiment of classifier 204. A number of the items shown in FIG. 5 are similar to those shown in FIGS. 3 and 4, and are similarly numbered. However, FIG. 5 shows that classifier 204 can include non-statistical components, such as non-statistical rule-based analyzer 230. Analyzer 230 can be, for example, a grammar-based robust parser. Grammar-based robust parsers are expressive and portable, can model the language in various granularity, and are relatively easy to modify in order to adapt to new language usages. While they can require manual grammar development or more supervision in automatic training for grammar acquisition and while they may be less robust in terms of unseen data, they can be useful to selector 221 in selecting the accurate task or class ID 214.

Therefore, rule-based analyzer 230 takes, as an input, natural language text 210 and provides, as its output, a class ID (and optionally, a confidence measure) corresponding to the target class. Such a classifier can be a simple trigger-class mapping heuristic (where trigger words or morphs in the input 210 are mapped to a class), or a parser with a semantic understanding grammar.

### Class Identification and Semantic Interpretation

Task classification may, in some instances, be insufficient to completely perform a task in applications that need more detailed information. A statistical classifier, or combination of multiple classifiers as discussed above, can only identify the top-level semantic information (such as the class or task) of a sentence. For example, such a system may identify the task corresponding to the natural language input sentence “List flights from Boston to Seattle” as the task “ShowFlights”. However, the system cannot identify the detailed semantic information (i.e., the slots) about the task from the users utterance, such as the departure city (Boston) and the destination city (Seattle).

The example below shows the semantic representation for this sentence:

<ShowFlight text=“list flights from Boston to Seattle”>

<Flight>

<City text=“Boston” name=“Depart”/>
<City text=“Seattle” name=“Arrive”/>

</Flight>

</ShowFlight>

In this example, the name of the top-level frame (i.e., the class or task) is “ShowFlight”. The paths from the root to the leaf, such as <ShowFlight> <Flight> <City text=“Boston” name=“Depart”/>, are slots in the semantic representation. The statistical classifiers discussed above are simply unable to fill the slots identified in the task or class.

Such high resolution understanding has conventionally been attempted with a semantic parser that uses a semantic grammar in an attempt to match the input sentences against grammar that models both tasks and slots. However, in such a conventional system, the semantic parser is simply not robust enough, because there are often unexpected instances of commands that are not covered by the grammar.

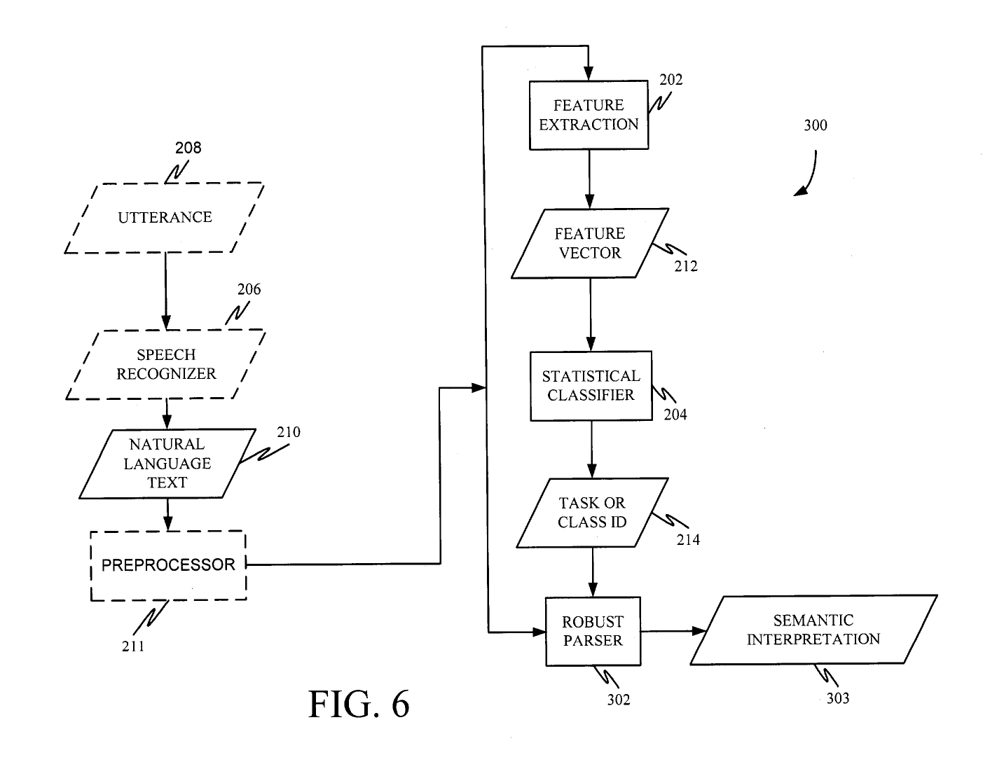

Therefore, FIG. 6 illustrates a block diagram of a portion of a natural language interface system 300 which takes advantage of both the robustness of statistical classifiers and the high resolution capability of semantic parsers. System 300 includes a number of things which are similar to those shown in previous figures, and are similarly numbered. However, system 300 also includes robust parser 302 which outputs a semantic interpretation 303. Robust parser 302 can be any of those mentioned in Ward, W. Recent Improvements in the CMU Spoken Language Understanding System, Human Language Technology Workshop 1994, Plansborough, N.J.; Wang, Robust Spoken Language Understanding in MiPad, Eurospeech 2001, Aalborg, Denmark; Wang, Robust Parser for Spoken Language Understanding, Eurospeech 1999, Budapest, Hungry; Wang, Acero Evaluation of Spoken Language Grammar Learning in ATIS Domain, ICASSP 2002, Orlando, Fla.; Or Wang, Acero, Grammar Learning for Spoken Language Understanding, IEEE Workshop on Automatic Speech Recognition and Understanding, 2001, Madonna Di Capiglio, Italy.

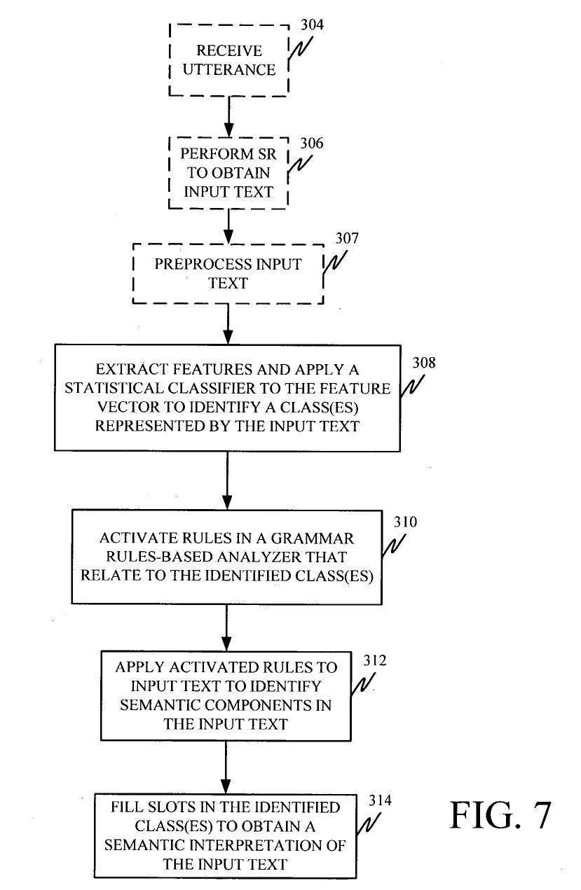

FIG. 7 is a flow diagram that illustrates the operation of system 300 shown in FIG. 6. The operation of blocks 208-214 shown in FIG. 6 operate in the same fashion as described above with respect to FIGS. 2-5. In other words, where the input received is a speech or voice input, the utterance is received as indicated by block 304 in FIG. 7 and speech recognition engine 206 performs speech recognition on the input utterance, as indicated by block 306. Then, input text 210 can optionally be preprocessed by preprocessor 211 as indicated by block 307 in FIG. 7 and is provided to feature extraction component 202 which extracts feature vector 212 from input text 210. Feature vector 212 is provided to statistical classifier 204 which identifies the task or class represented by the input text. This is indicated by block 308 in FIG. 7.

The task or class ID 214 is then provided, along with the natural language input text 210, to robust parser 302. Robust parser 302 dynamically modifies the grammar such that the parsing component in robust parser 302 only applies grammatical rules that are related to the identified task or class represented by ID 214. Activation of these rules in the rule-based analyzer 302 is indicated by block 310 in FIG. 7.

Robust parser 302 then applies the activated rules to the natural language input text 210 to identify semantic components in the input text. This is indicated by block 312 in FIG. 7.

Based upon the semantic components identified, parser 302 fills slots in the identified class to obtain a semantic interpretation 302 of the natural language input text 210. This is indicated by block 314 in FIG. 7.

Thus, system 300 not only increases the accuracy of the semantic parser because task ID 214 allows parser 302 to work more accurately on sentences with structure that was not seen in the training data, but it also speeds up parser 302 because the search is directed to a subspace of the grammar since only those rules pertaining to task or class ID 214 are activated.

### Statistical Classifier with Stored Lexicon

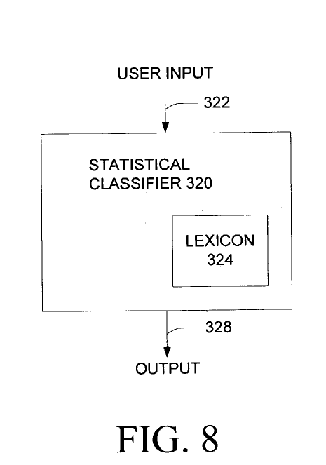

Another aspect of the present invention as illustrated in FIG. 8 is a statistical classifier 320 that receives information 322 from a user indicative of a natural-language command for a computer in order to perform a desired function. The statistical classifier 320, which can take the forms discussed above, accesses a stored lexicon 324, having information related to token frequency. The statistical classifier 320 ascertains one or more possible intents of the user's input 322 as an output 328. As will be discussed further below, the statistical classifier 320 can be used to distinguish whether the input 322 is related to a natural-language command or a search query for obtaining possible relevant documents such as in an information retrieval system as well as ascertain and provide an output indicative of the most likely natural-language command or target class from a set of possible natural-language commands or target classes.

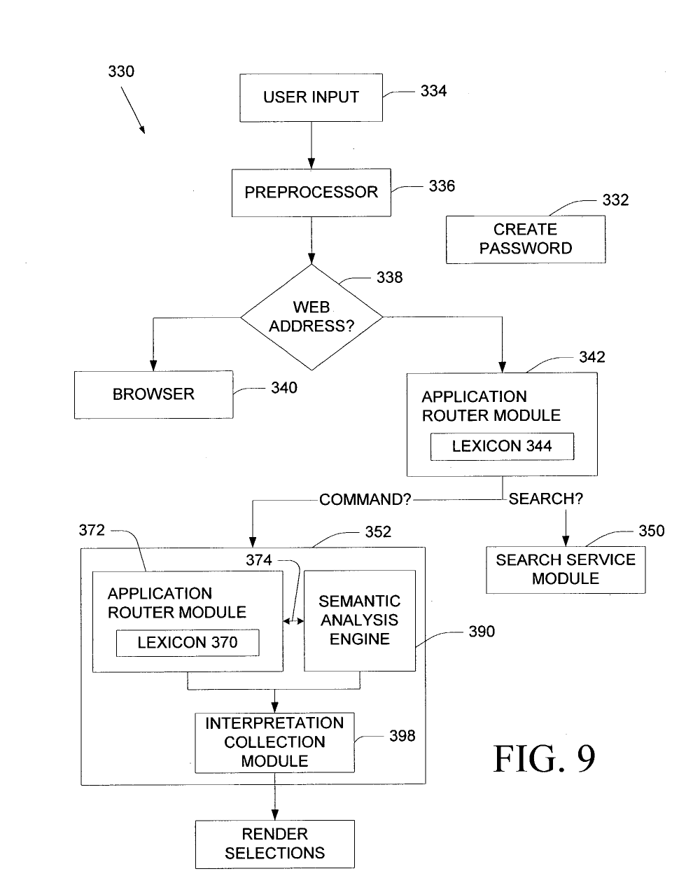

FIG. 9 is an exemplary environment or application for incorporating aspects of the present invention. In particular, FIG. 9 illustrates processing of input from a user into a system 330 that can access information over a network, such as the Internet, using a URL (Uniform Resource Locator) address, performs searches based on search queries provided by the user, or invokes selected actions using a natural-language command as input. A system such as described is offered by Microsoft Corporation of Redmond, Wash. as MSN8™.

As indicated above, system 330 can process various forms of input provided by the user. For convenience, the user can enter the input in a single field illustrated at 332. Generally, system 330 processes text in accordance with that entered in field 332. The input is indicated in FIG. 9 at 334 as user input and can be entered in field 332 using any convenient input device, keyboard, mouse, etc. However, user input 334 should also be understood to cover other forms of input such as utterances, handwriting or gestures using well-known converters to convert the given form of input into a text string or its equivalent.

Having received the user input 334 and performed any necessary conversion to a text string or other forms of preprocessing, as may be desired, by preprocessor 336, system 330 ascertains whether the user input 334 corresponds to a request by the user to access a desired document, rather than requesting a search or providing a natural-language command. This portion of system 330 is not directly pertinent to the present invention, but rather, is provided for the sake of completeness. At decision block 338, system 330 can ascertain if the user input 334 corresponds to a URL simply by examining whether or not the format corresponds to a URL format. For example, if whether or not the user input 334 includes required prefixes or suffixes. If the user input 334 does correspond to a URL, the text string corresponding to the user input 334 is provided to a browser 340 for further processing.

If, on the other hand, it is determined that the user input 334 does not correspond to a URL, the text string is then provided to an application router module 342. Application router module 342 is similar to that described above with respect to FIG. 1 and is a statistical classifier based module, which at run-time, takes the text string of the user input 334 and compares it to a stored lexicon 344 to ascertain whether, in this embodiment, the text string corresponds to a search request made by the user or a natural-language command. Based on relative probabilities that the user string corresponds to a search request or a natural-language command, the application router module 342 will forward the text string to a search service module 350, which, for example, can also be embodied in a browser application. The application router module 342 can also forward the text string corresponding to the user input 334 to a natural-language processing system 352, wherein further processing of the text string can be formed in a manner described below to ascertain the desired command, or at least a list of possible desired commands that the user may of intended. The natural-language command that can be processed by the natural-language processing system 352 varies depending upon the product domain or the scope of applications that can be invoked with natural-language commands. For instance, such applications can include e-mail applications, which would allow a user to create, reply or otherwise manipulate messages in an e-mail application. Other examples include creating or manipulating photos or other images with image processing systems, changing passwords or user names in the system, etc. In one embodiment, the natural-language processing system 352 includes a statistical classifier to ascertain the intent of the user's command and provide each of the domain specific application such as an e-mail application, image processing application, etc. and provide relevant information corresponding to the user input in a predefined structure that can be readily accepted by the domain specific application.

### Creation of Lexicon

Before describing further aspects of the application router module 342 or the natural-language processing system 352, it may be helpful first to discuss creation of the lexicon used to process the text string of the user input 334.

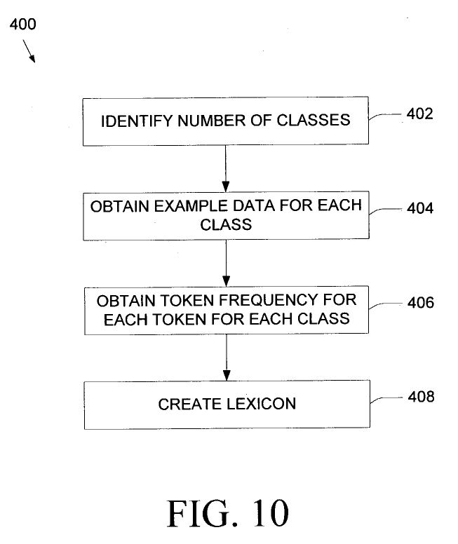

FIG. 10 illustrates an exemplary method 400 for creation of a lexicon such as lexicon 344 in FIG. 9. At step 402, the number of classes to which input text strings will be classified is identified. Using the application router module 342 by way of example, two classes are used. The first class pertains to a user input 334 that corresponds to a search request, while the other class pertains to natural-language commands that are provided to the natural-language processing system 352.

At step 404, examples of user input for each of the classes is obtained. The examples comprise a training corpus, which will be used to form the lexicon. Typically the training corpus includes many examples, in the order of thousands, if not more in order to provide as many different examples of user input for each of the identified classes. If desired, the training corpus can include common spelling errors, or other forms of grammatical mistakes. In this manner, the form of the user input 334 received during run-time need not be correctly spelled or grammatically correct. Alternatively, some mistakes such as spelling can be corrected in the training corpus prior to analysis; however, this may also require that the user input 334 undergo the same corrections prior to processing.

At step 406, a training corpus is analyzed for each class to ascertain the lexical frequency of tokens appearing in the examples for each class. Any known tokenizer, which is configured to break each of the examples in the training corpus into its component tokens, and label those tokens, if necessary, can be used to generate the tokenized example strings. As used herein, a token can include individual words, acronyms or named entities. Named entities are more abstract than words that might occur in a dictionary and include domain-neutral concepts like names, dates and currency amounts as well as domain-specific concepts or phrases that may be identified on a per class basis (e.g., “user account”, “movie title”, etc.). In addition, tokens can include auxiliary features of the input strings such as punctuation marks, for instance, the placement thereof, or other language features, such as noun and verb placement, etc. In this regard, a natural-language analyzer can be executed upon the training corpus data in order to decide which features are most predictive of the various categories to be classified. The natural-language analyzer includes the use of parsers to analyze the training corpus examples based on sentence structure. If desired, this analysis can be used in step 402 in order to identify the number of classes to be formed.

Analysis of the training corpus for each class in step 406 includes counting the frequency of each token for each class. The value obtained is relative to the number of examples for each class. Thus, a word such as “cats” may occur fifteen times in a training corpus for search or query examples totaling ten thousand, or “15/10,000”. Again, each of the tokens for each of the classes is tabulated in this manner. It should be noted that, in a further embodiment, token frequency can be based on lemma analysis where various inflections can be removed. For instance, use of the word “changing” or “changed” can be normalized or counted with respect to “change”. Likewise, the token “pictures” can be counted with respect to “picture”.

In yet a further embodiment, generalized tokens can be created and tabulated based upon the occurrence of specific tokens. For example, a general token “name” can include a count for all the proper names found in the training corpus for each class. For example, “George Bush”, “Bruce Springstein”, “Jennifer Barnes” can all be tabulated for the general “name” token. General tokens can be domain neutral or domain specific based upon a given application.

At step 408, the lexicon is created. In general, the lexicon stores the token frequency of each token with respect to each class. In the system illustrated in FIG. 9, if desired, separate lexicons can be created for the application router module 342 and for use in the natural-language processing system 352 or, if desired, a single lexicon for all the classes can be created and used.

In yet a further embodiment, the training corpus can be tailored to the user if during run-time, the user input 334 is captured and correlated with the action intended by the user, particularly if the user must select the correct action from a list of actions. The lexicon can be stored locally on the client device to which the user is providing user input 334; however, if desired, the lexicon can be stored remotely. In either case, the lexicon is updated based on the tokens present in the user input 334 as correlated with the desired class of action.

### Operation of Statistical Classifier with Lexicon

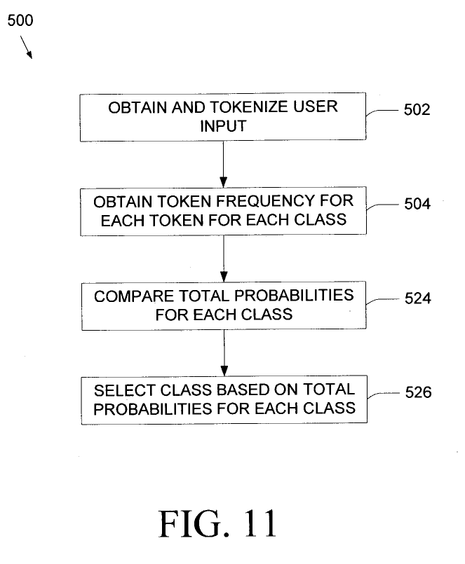

FIG. 11 illustrates a method 500 for processing a user input using a lexicon as described above. With reference to FIG. 9, by way of example, the text string corresponding to the user input 334 is provided to the application router module 342, assuming that the text string of the user input 334 does not correspond to a URL address. At step 502, the application router module 342 breaks the text string corresponding the user input 334 into its component tokens, labeling the tokens, if necessary in a manner similar to the discussed above for the examples used in the training corpus.

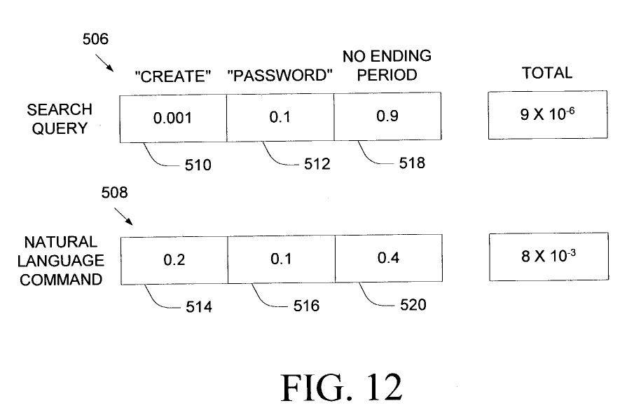

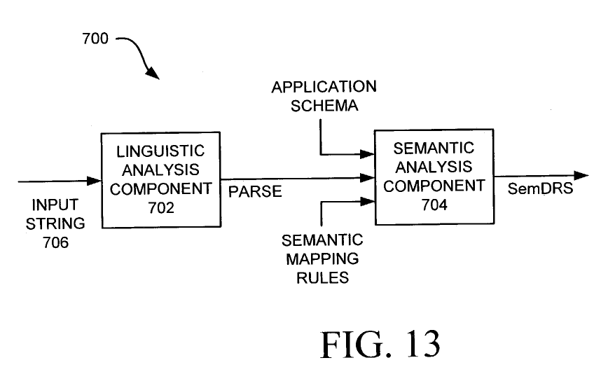

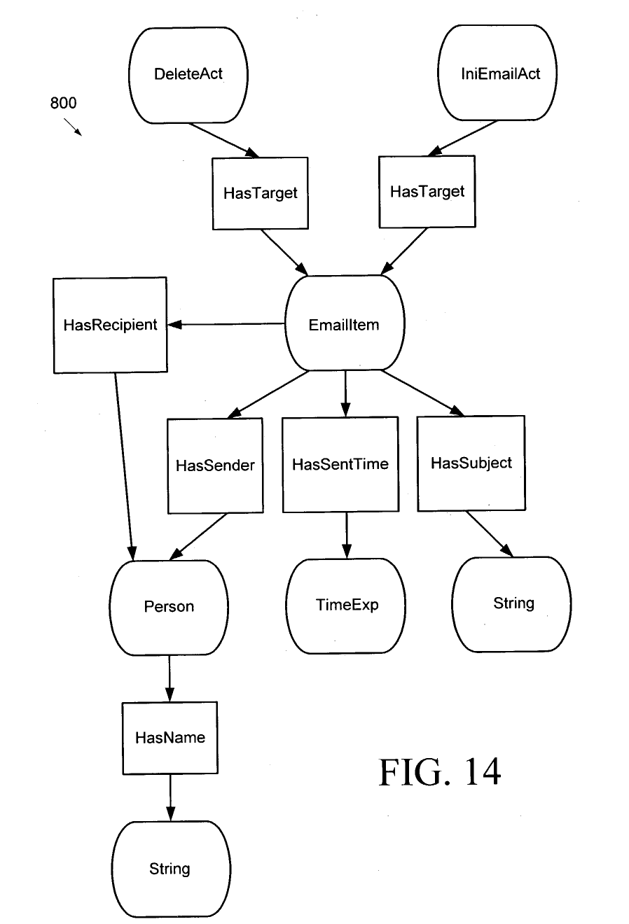

At step 504, the probabilities for each token are obtained from the lexicon with respect to each class under consideration. FIG. 12 is one exemplary technique for calculating the probabilities for each of the tokens for each of the classes. In FIG. 12, a probability array is used to store the token frequencies obtained from the lexicon with respect to each of the classes under consideration. For the application router module 342, as discussed above, two classes are present, a first class corresponding to whether the user input pertains to a search request, while the second pertains to whether the user input is a natural-language command. In this example, probability array 506 is used to store token frequencies for the class pertaining to a search query, while probability array 508 stores the token frequencies for the class corresponding to a natural-language command. Each of the probability arrays 506 and 508 can be considered “dynamic” in that the number of array elements corresponds to the number of tokens present in the text string of the user input 334 under consideration.

Use of the probability arrays 506 and 508 may be best understood by way of example. Suppose the text string for the user input corresponds to the tokens, after tokenization, “create” and “password”. Population of the probability arrays 506 and 508 is a function of each token for each class. In particular, if the token is appropriate for a class, and the token is not a named entity for a different class, and there exists no token with a larger lexical span that covers the token (for instance “log” with respect to “log in”), then the frequency of the token with respect to the class as found in the lexicon is added to or stored in the probability array 506 for the first class, the same analysis being used for adding the word frequency of the token to the probability array 508 of the second class as well. Values 510, 512, 514 and 516 have been added to the arrays 506 and 508 for each of the tokens “create” and “password”.

Although each token can be processed similarly in this manner, in a further embodiment, for tokens comprising auxiliary features such as punctuation marks, the token frequencies can be added to the probability arrays in a slightly different manner. In particular, the presence or absence of an auxiliary feature may be more instructive as to whether or not the user input corresponds to the class. Thus, for each class under consideration, wherein each class includes a list of auxiliary feature tokens, the presence or absence of which is indicative of the input corresponding to the class, causes the application router module 342 to examine the input for the presence of each auxiliary feature defined in the class. If the auxiliary feature is found to apply to the input an additional array element is added to the corresponding probability array 506 or 508 for the class under consideration with the frequency of the auxiliary feature added therein as a function of the stored lexicon data. (It should be noted local variables could also be used.) However, if a feature does not apply to the input string, then, the probability added to the probability array can be expressed as:

1—(frequency of auxiliary feature in lexicon).

In this manner, whether or not the auxiliary feature is present, either will cause an adjustment in the corresponding probability arrays.

In FIG. 12, an auxiliary feature comprising whether or not the user input 334 included an ending period is indicated at 518 and 520. Assuming that a search request in the training data generally does not include an ending period, and since, in this example, the tokenized input string “create” and “password” does not contain an ending period, the probability for no ending period is relatively high as 0.9 (1-0.1, where presence of an ending period for a search query is 0.1). Likewise, since an ending period may be more common, a lack of a period being present in this example is 0.4 (1-0.6, where presence of an ending period in a natural language command is 0.6).

The foregoing emphasizes that auxiliary features don't necessarily have to correspond directly to tokens, nor do they have to be tested for after tokenization of the input. In this manner, an auxiliary feature can be viewed as “does the input have property X?”. For example, “does the input end with a period?”; “does the input parse as an imperative?”; “does the input have more than 10 words?”, etc.

At this point, a probability added to the probability array for each class may not be solely based upon the token frequencies found in the lexicon. For instance, if a token, such as a word or acronym, was not present in the training corpus used to create the lexicon, a value of “0” in the probability array may inadvertently inhibit further processing. In such cases, a default word frequency value can be used. For instance, if a token frequency is not located for a class, the default value may be used. In one embodiment, the default value corresponds to (1/T), where T is the number of examples found in the training corpus for all classes combined. In one embodiment, biasing unseen tokens to a search request is to scale this default value upwards for the class pertaining to a search request. For example, a scaling factor of 10 can be used. In a further embodiment, the scaling factor can be computed where the model is first trained and then test data is used to see how frequently unseen words are encountered. The ratio of these frequencies provides an appropriate scaling factor.

As appreciated by those skilled in the art, the statistical classifier can be configured to apply the scaling factor to the default value, which then is added to the array. Alternatively, the statistical classifier can be configured to apply the scaling factor to the array as a separate entry. Further, the scaling factors can be greater or less than 1 to favor or disfavor a class by increasing or decreasing the corresponding probability.

At step 524, the probabilities for each of the classes are analyzed in order to determine which class is more likely for user input 334. Typically, this may involve multiplying each of the token frequency probabilities together where a final calculated probability is indicative of the class to which the user input pertains.

Selection of a class or classes is then made at step 526 based upon the relative probabilities calculated at step 524. Although the highest probability may be chosen and considered to be the intent of the user providing the user input 334, in a further embodiment, the relative probabilities between each of the classes are compared as a measure of confidence. If the total probability associated with the probability array of one class is significantly higher, when compared relative to the total probability of another class, there might exist a higher confidence that the class with the higher total probability is correct. Likewise, in contrast, if the total probabilities for each of the arrays 506 and 508 are analyzed relative to each other, and one class is not significantly higher, the class with the higher may not be chosen automatically. In other words, in one embodiment, the user input may not strongly correlate to one of the classes, because there exists no one class that has a relative probability that significantly exceeds all others. A threshold can be used as a measure of confidence. Thus, if the threshold is exceeded, the class with the lower total probability can be discarded, whereas if the threshold is not exceeded both applications for both of the classes can invoked or at least rendered for selection by the user. Likewise, the threshold value can be used to decide whether to automatically execute a command rather than present the user with a list of interpretations.

The use of thresholds can be expanded for applications having more than two classes. Thus, each combination of classes can have one or more thresholds. For example, a first threshold can be provided for class A having a probability greater than class B (class A/class B), while a second threshold can be provided for class B having a probability greater than class A (class B/class A). In general, if the relative probability between each of the classes is not high enough, the list of options presented to the user corresponding to the user's intent of user input 334 can include all classes where the thresholds were not exceeded, provided that there exists no one class that was significantly higher, as determined by the thresholds, which could be automatically invoked.

As indicated above, the natural-language processing system 352 also includes a statistical classifier that operates in the manner described above with respect to the application router module 342 where a lexicon 370 is accessed and used to ascertain the intended action to be performed. In the embodiment illustrated in FIG. 9, as discussed above, the application router module 342 is used to ascertain if the user input 334 corresponds to a command line or to a search, whereas an action router module 372 of the natural-language processing system 352 is used to further refine which action the user intends based on the user input 334.

By executing the algorithm described above and illustrated in FIGS. 11 and 12, the action router module 372 will provide an output indicative of the action intended by the user in the form of information which can be provided to an application such as an e-mail messaging application, image processing application, etc. in a convenient form for the application to complete the task. In an alternative embodiment, the action router module 372 can provide an ordered list of the possible actions intended by the user based on the probabilities calculated as a function of the token in the user input 334. The possible actions, if or if not there exists an action with the highest probability, can be rendered to the user in manner such that the user can identify which action was intended. For instance, a short list can be rendered visually in a graphical user interface allowing the user to select the intended action. In an alternative embodiment, the actions can be rendered audibly, where speech recognition or DTMF (Dual Tone Modulated Frequency) interaction can allow the user to select the appropriate action. The specific manner in which the user is allowed to indicate which action was intended based on the rendered list can take many forms as appreciated by those skilled in the art and as such, the examples provided herein should not be considered limiting.

In general, the output from the action router module 372 can be a list of possible commands the user intended. The parameters of each command are defined by the application author and includes parameters or arguments, required or optional, that may be present in the user input. In a further embodiment, the action router module 372, having determined which class is applied to the user input based on probability due to token frequency, can have a predefined command schema with a corresponding list of required or optional parameters. For each command identified, the action router module 372 can return to the tokenized string in an effort to fill in any parameters provided by the user. Having defined the list of parameters or arguments for each command, the action router module 372 searches for the occurrence of the parameter argument in the available forms of the user input 334. A suitable recognizer (linguistic and/or semantic) can be used to identify arguments or parameters in the user input. In many cases, the user input 334 may not include all required parameters to invoke a particular action. In one embodiment, as much information as was available from the user input can be provided to the application program, such as an e-mail messaging program, which in turn will prompt the user for any additional information as required. In a further embodiment, after the user has selected the most appropriate command from the list of the command possibilities, the action router module 372 or another module can prompt the user for additional information prior to invoking the corresponding application to process the command.

In a further embodiment, the natural-language processing 352 can include a semantic analysis engine 390. In general, the semantic analysis engine 390 receives the tokenized text string for the user input 334 and can perform semantic analysis that interprets a linguistic structure output by a natural language linguistic analysis system. The semantic analysis engine 390 converts the linguistic structure output by the natural language linguistic analysis system into a data structure model referred to as a semantic discourse representation structure (SemDRS).

FIG. 13 is a block diagram of components within semantic analysis engine 390. Semantic analysis engine 390 includes a linguistic analysis component 702 and a semantic analysis component 704.

In engine 390, the text string of input 334 is input to linguistic analysis component 702. Linguistic analysis component 702 analyzes the input string to produce a parse which includes, in one illustrative embodiment, a UDRS, a syntax parse tree, a logical form, a tokenized string, and a set of named entities. Each of these data structures is known, and will therefore be discussed only briefly. Linguistic analysis component 702 may illustratively output a plurality of different parses for any given input text string, ranked in best-first order.

The UDRS (underspecified discourse representation structure) is a linguistic structure output by the linguistic analysis component 702. The syntactic parse tree and logical form graphs are also conventional dependency, and graph structures, respectively, generated by natural language processing in linguistic analysis component 702. The syntactic parse tree and logical forms are described in greater detail in U.S. Pat. No. 5,995,922, to Penteroudakis et al., issued on Nov. 30, 1999. The tokenized string is that as described above. Named entities are entities, such as proper names, which are to be recognized as a single unit.

While only some of these elements of the parse may need to be provided to semantic analysis component 704, in one illustrative embodiment, they are all generated by (or obtained by) linguistic analysis component 702 and provided (as parts of the parse of string 706) to semantic analysis component 704.

Semantic analysis component 704 receives, as its input, the parse from syntactic analysis component 702, an application schema, and a set of semantic mapping rules. Based on these inputs, semantic analysis component 704 provides, as its output, one or more SemDRS's which represent the input string in terms of an entity-and-relation model of a non-linguistic domain (e.g., in terms of an application schema).

The application schema may illustratively be authored by an application developer. The application schema is a model of the application's capabilities and behavior according to an entity-and-relation model, with associated type hierarchy. The semantic mapping rules may also illustratively be authored by the application developer and illustrate a relation between input UDRS's and a set of SemDRS fragments. The left hand side of the semantic mapping rules matches a particular form of the UDRS's, while the right hand side specifies a SemDRS fragments which corresponds directly to a portion of the application schema. By applying the semantic mapping rules to the UDRS, and by maintaining a plurality of mapping and other data structures, the semantic analysis component 704 can generate a total SemDRS, having a desired box structure, which corresponds precisely to the application schema, and which also represents the input string, and the UDRS input to the semantic analysis component 704.

FIG. 14 represents an example of an application schema 800. The schema 800 is a graph of entities and relations where entities are shown in circles (or ovals) and relations are shown in boxes. For example, the schema 800 shows that the application supports sending and deleting various specific email messages. This is shown because email items can be the target of the “DeleteAct” or the “InitiateEmailAct”.

Further, those email messages can have senders or recipients designated by a “Person” who has a “Name” indicated by a letter string. The email items can also be specified by the time they were sent and by their subject, which in turn is also represented by a character string.

The job of the semantic analysis component 704 of the present invention is to receive the parse and the UDRS and interpret it precisely in terms of the application schema such as the schema 800 of FIG. 14. This interpretation can then be passed to the application through SemDRS(s) where it will be readily understood.

Operation of the semantic analysis component 704 is not relevant for purposes of the aspects of the present invention as discussed below. A complete description is provided in U.S. patent application Ser. No. 10/047,462, filed Jan. 14, 2002 and entitled “SEMANTIC ANALYSIS SYSTEM FOR INTERPRETING LINGUISTIC STRUCTURES OUTPUT BY A NATURAL LANGUAGE LINGUISTIC ANALYSIS SYSTEM”.

As indicated above, the semantic analysis component 704 for the semantic analysis engine 390 interprets the text string for the user input 334 in terms of the application schema and provides SemDRS(S) that can be passed to the application where it is readily understood. In a further embodiment of the present invention and as an additional aspect thereof, both the statistically based action router module 372 and the semantic analysis engine 390 can each provide an output that is in the same format so that the outputs can be combined by an interpretation collection module 398 (illustrated in FIG. 9) whereat the selections can be rendered to the user for selection.

As described above, the action router module 372 ascertains one or more classes for the tokenized input string using the lexicon 370. Each class includes a classification command, commonly authored by the application author. Each classification command can be associated with a node in the application schema, which in turn, has a correlation to the direct format for the application, herein SemDRS(S). In FIG. 9, the action router module 372 and the semantic analysis engine 390 are shown connected through double arrow 374 for this purpose. As appreciated by those skilled in the art and if desired, the application router module 372 can store this information remotely from the semantic analysis engine 390.

Both the action router module 372 and the semantic analysis engine 390 thus produce possible interpretations of the user input 334 as natural-language commands. The interpretation collection module 398 receives the interpretations from the action router module 372 and the semantic analysis engine 390 and combines the interpretations and can render the interpretations for selection by the user, if more than one interpretation exists. Generally, the interpretations from the action router module 372 and the semantic analysis engine 390 are unioned together. An advantage of both the action router module 372 and the semantic analysis engine 390 providing interpretations in the same format, herein SemDRS, is that, from the perspective of the client application, the client application does not know which interpretation has been provided by which module, thus the client application need only interpret one format of the interpretation or interpretations. In addition, if the same format is used, duplicate interpretations can be easily removed. Furthermore, it is possible that an interpretation from one of the modules 370 and 372 can be a subset of another interpretation also provided by the modules 370 and 372. An example of a subset is “send e-mail” which could be a subset of “send e-mail to Jennifer”. The interpretation collection module 398 can render all forms of interpretations, if desired. However, in some situations, it may be desirable to delete the subset interpretations since they do not contain as much information and may make the list for interpretation collection module 398 unnecessarily long. However, in yet another further embodiment, subset interpretations can be deleted on a class by class basis. It can thus be seen that different aspects of the present invention can be used to obtain improvements in phases of processing natural language in natural language interfaces including identifying a task represented by the natural language input (text classification) and filling semantic slots in the identified task. The task can be identified using a statistical classifier, multiple statistical classifiers, or a combination of statistical classifiers and rule-based classifiers. The semantic slots can be filled by a robust parser by first identifying the class or task represented by the input and then activating only rules in the grammar used by the parser that relate to that particular class or task. In another aspect of the invention, the statistical classifier can be used to ascertain if the textual input comprises a search query or a natural language command.

Although the present invention has been described with reference to particular embodiments, workers skilled in the art will recognize that changes may be made in form and detail without departing from the spirit and scope of the invention.

What is claimed is:

1. A text classifier in a natural language interface that receives a natural language user input, the text classifier comprising:
a feature extractor extracting a feature vector from a textual input indicative of the natural language user input;
a statistical classifier coupled to the feature extractor outputting a class identifier identifying a target class associated with the textual input based on the feature vector.

2. The text classifier of claim 1 wherein the statistical classifier comprises:
a plurality of statistical classification components each outputting a class identifier.

3. The text classifier of claim 2 wherein the statistical classifier comprises:
a class selector coupled to the plurality of statistical classification components and selecting one of the class identifiers as identifying the target class.

4. The text classifier of claim 3 wherein the class selector comprises a voting component.

5. The text classifier of claim 3 wherein the class selector comprises an additional statistical classifier.

6. The text classifier of claim 1 and further comprising:
a rule-based classifier receiving the textual input and outputting a class identifier; and
a selector selecting at least one of the class identifiers as identifying the target class.

7. The text classifier of claim 1 and further comprising:
a rule-based parser receiving the textual input and the class identifier and outputting a semantic representation of the textual input.

8. The text classifier of claim 7 wherein the semantic representation includes a class having slots, the slots being filled with semantic expressions.

9. The text classifier of claim 1 and further comprising:
a pre-processor identifying words in the textual input having semantic content.

10. The text classifier of claim 9 wherein the preprocessor is configured to remove words from the textual input that have insufficient semantic content.

11. The text classifier of claim 9 wherein the preprocessor is configured to insert tags for words in the textual input, the tags being semantic labels for the words.

12. The text classifier of claim 1 wherein the feature vector is based on words in a vocabulary supported by the natural language interface.

13. The text classifier of claim 12 wherein the feature vector is based on n-grams of the words in the vocabulary.

14. The text classifier of claim 12 wherein the feature vector is based on words in the vocabulary having semantic content.

15. The text classifier of claim 1 wherein the statistical classifier comprises a Naive Bayes Classifier.

16. The text classifier of claim 1 wherein the statistical classifier comprises a support vector machine.

17. The text classifier of claim 1 wherein the statistical classifier comprises a plurality of class-specific statistical language models.

18. The text classifier of claim 1 wherein a number c of classes are supported by the natural language interface and wherein the statistical classifier comprises c class-specific statistical language models.

19. The text classifier of claim 1 and further comprising:
a speech recognizer receiving a speech signal indicative of the natural language input and providing the textual input.

20. The text classifier of claim 1 wherein the statistical classifier identifies a plurality of n-best target classes.

21. The text classifier of claim 20 and further comprising:
an output displaying the n-best target classes for user selection.

22. The text classifier of claim 2 wherein each statistical classifier outputs a plurality of n-best target classes.

23. A computer-implemented method of processing a natural language input for use in completing a task represented by the natural language input, comprising:
performing statistical classification on the natural language input to obtain a class identifier for a target class associated with the natural language input;
identifying rules in a rule-based analyzer based on the class identifier; and
analyzing the natural language input with the rule-based analyzer using the identified rules to fill semantic slots in the target class.

24. The method of claim 23 and further comprising:
prior to performing statistical classification, identifying words in the natural language input that have semantic content.

25. The method of claim 23 wherein the natural language input is represented by a speech signal and further comprising:
performing speech recognition on the speech signal prior to performing statistical classification.

26. The method of claim 23 wherein performing statistical classification comprises:
performing statistical classification on the natural language input using a plurality of different statistical classifiers; and
selecting a class identifier output by one of the statistical classifiers as representing the target class.

27. The method of claim 26 wherein selecting comprises:
performing statistical classification on the class identifiers output by the plurality of statistical classifiers to select the class identifier that represents the target class.

28. The method of claim 26 wherein selecting comprises:
selecting the class identifier output by a greatest number of the plurality of statistical classifiers.

29. The method of claim 23 and further comprising:
performing rule-based analysis on the natural language input to obtain a class identifier; and
identifying the target class based on the class identifier obtained from the statistical classification and the class identifier obtained from the rule-based analysis.

30. A system for identifying a task to be performed by a computer based on a natural language input, comprising:
a feature extractor extracting features from the natural language input; and
a statistical classifier, trained to accommodate unseen data, receiving the extracted features and identifying the task based on the features.

31. The system of claim 30 wherein the statistical classifier and wherein probabilities used by the statistical classifier are smoothed using smoothing data to accommodate for the unseen data.

32. The system of claim 31 wherein smoothing data is obtained using cross-validation data.

33. A text classifier identifying a target class corresponding to a natural language input, comprising:
a feature extractor extracting a set of features from the natural language input; and
a Naïve Bayes Classifier receiving the set of features and identifying the target class based on the set of features.

34. The text classifier of claim 33 wherein the target class is indicative of a task to be performed based on the natural language input.

35. The text classifier of claim 34 and further comprising:
a preprocessor identifying content words in the natural language input prior to the feature extractor extracting the set of features.

36. The text classifier of claim 35 wherein the preprocessor identifies the content words by removing from the natural language input words having insufficient semantic content.

37. A text classifier identifying a target class corresponding to a natural language input, comprising:
a feature extractor extracting a set of features from the natural language input; and
a statistical language model classifier receiving the set of features and identifying the target class based on the set of features.

38. The text classifier of claim 37 wherein the set of features includes n-grams.

39. The text classifier of claim 37 and further comprising:
a preprocessor identifying content words in the natural language input prior to the feature extractor extracting the set of features.

40. A text classifier identifying one or more target classes corresponding to a natural language input, comprising:
a feature extractor extracting a set of features from the natural language input; and
a plurality of statistical classifiers receiving the set of features and identifying a target class based on the set of features.

41. The text classifier of claim 40 wherein each statistical classifier outputs a class identifier based on the set of features and further comprising:
a selector receiving the class identifiers from each of the statistical classifiers and selecting the target class as a class identified by at least one of the class identifiers.

42. The text classifier of claim 40 and further comprising:
a preprocessor identifying content words in the natural language input prior to the feature extractor extracting the set of features.

43. A text classifier identifying a target class corresponding to a natural language input, comprising:
a feature extractor extracting a set of features from the natural language input;
a statistical classifier receiving the set of features and outputting a class identifier based on the set of features;
a rules based classifier outputting a class identifier based on the natural language input; and
a selector selecting a target class based on the class identifiers output by the statistical classifier and the rule-based classifier.

44. The text classifier of claim 43 and further comprising:
a preprocessor identifying content words in the natural language input prior to the feature extractor extracting the set of features and prior to the rule-based classifier receiving the natural language input.

45. A text classifier identifying a target task to be completed corresponding to a natural language input, comprising:
a feature extractor extracting a set of features from a textual input indicative of the natural language input;
a statistical classifier receiving the set of features and identifying the target task based on the set of features; and
a rule-based parser receiving the textual input and a class identifier indicative of the identified target task and outputting a semantic representation of the textual input.

46. The text classifier of claim 45 wherein the rule-based parser is configured to identify semantic expressions in the textual input.

47. The text classifier of claim 46 wherein the semantic representation includes a class having slots, the slots being filled with the semantic expressions.

48. The text classifier of claim 45 and further comprising:
a pre-processor identifying words in the textual input having semantic content.

49. The text classifier of claim 48 wherein the preprocessor is configured to remove words from the textual input that have insufficient semantic content.

50. The text classifier of claim 48 wherein the preprocessor is configured to insert tags for words in the textual input, the tags being semantic labels for the words.

51. The text classifier of claim 48 wherein the preprocessor is configured to replace words in the textual input with semantic tags, the semantic tags being semantic labels for the words.

52. A text classifier in a natural language interface that receives a natural language user input, the text classifier comprising:
a statistical classifier configured to receive a textual input and output a class identifier identifying a target class associated with the textual input.

53. The text classifier of claim 52 wherein the statistical classifier is configured to form tokens of the textual input and access a lexicon to ascertain token frequency of each token corresponding to the textual input in order to identify a target class. [LCW1]

54. The text classifier of claim 53 wherein the statistical classifier is configured to calculate a probability that the textual input corresponds to each of a plurality of possible classes based on token frequency of each token corresponding to the textual input.

55. The text classifier of claim 54 wherein the statistical classifier is configured to use a default value for token frequency if a token is not present in the lexicon.

56. The text classifier of claim 54 wherein the statistical classifier is configured to apply a scaling factor to a probability of a class based on whether a token is present in the lexicon.

57. The text classifier of claim 56 wherein the scaling factor varies as a function of the class.

58. The text classifier of claim 57 wherein the scaling factor for a class is a function of how frequently unseen words are encountered for the class.

59. The text classifier of claim 53 wherein tokens in the lexicon comprise words.

60. The text classifier of claim 53 wherein tokens in the lexicon comprise groups of words.

61. The text classifier of claim 53 wherein tokens in the lexicon comprise auxiliary features.

62. The text classifier of claim 53 wherein tokens in the lexicon comprise named entities.

63. The text classifier of claim 53 wherein tokens in the lexicon comprise generalized tokens that represent specific words.

64. The text classifier of claim 53 wherein the statistical classifier is configured to provide a list of class identifiers identifying target classes associated with the textual input.

65. The text classifier of claim 64 wherein the statistical classifier is configured to calculate a probability that the textual input corresponds to each of a plurality of possible classes based on token frequency of each token corresponding to the textual input.

66. The text classifier of claim 65 wherein the statistical classifier is configured to select a target class as a function of comparing calculated probabilities for each possible class.

67. The text classifier of claim 66 wherein the statistical classifier is configured to select a target class as a function of comparing calculated probabilities exceeding a selected threshold.

68. The text classifier of claim 67 wherein the statistical classifier is configured to use a first selected threshold for a first set of classes and a second selected threshold for a second set of classes.

69. The text classifier of claim 67 wherein the statistical classifier is configured to use a first selected threshold for a set of classes when a first class of the set has a greater probability than a second class of the set, and is configured to use a second selected threshold when the second class of the set has a greater probability than the first class of the set.

70. The text classifier of claim 53 wherein the lexicon includes a first class associated with natural language commands and a second class associated with search queries.

71. The text classifier of claim 52 and further comprising an interpretation collection module configured to receive the output from statistical classifier and combine the output with an output from a semantic analyzer analyzing the textual input to form a combined list of possible interpretations.

72. The text classifier of claim 71 wherein the interpretation collection module is configured to remove duplicates in the combined list.

73. The text classifier of claim 72 wherein the interpretation collection module is configured to ascertain if a first interpretation in the combined list is a subset of another interpretation.

74. A computer-implemented method of processing textual input, comprising:
performing statistical classification on the textual input to obtain a target class associated with the textual input; and
forwarding the textual input to a search service if the target class identified relates to the textual input comprising a search query.

75. The computer-implemented method of claim 74 and further comprising:
forwarding the textual input to a statistical classifier if the target class identified relates to the textual input comprising a natural-language command; and
performing statistical classification on the textual input to obtain a target class indicative of a natural language command associated with the textual input.

76. The computer-implemented method of claim 74 wherein the step of performing includes forming tokens of the textual input and accessing a lexicon to ascertain token frequency of each token corresponding to the textual input in order to identify a target class.

77. The computer-implemented method of claim 76 wherein the step of performing includes calculating a probability that the textual input corresponds to each of a plurality of possible classes based on token frequency of each token corresponding to the textual input.

78. The computer-implemented method of claim 77 wherein the step of performing includes providing a list of class identifiers identifying target classes associated with the textual input.

79. The computer-implemented method of claim 78 wherein the step of performing includes selecting a target class for the list as a function of comparing calculated probabilities for each possible class.

80. The computer-implemented method of claim 77 and further comprising taking action as a function of a calculated probability exceeding a selected threshold.

81. A computer-implemented method of processing textual input comprising a natural-language command, comprising:
performing statistical classification on the textual input to obtain a target class and associated interpretation with the textual input; and
combining the interpretation from performing statistical classification with an interpretation from another form of analysis of the textual input to form a combined list of possible interpretations.

82. The computer-implemented method of claim 81 wherein combining includes removing duplicates in the combined list.

83. The computer-implemented method of claim 82 wherein combining includes ascertaining if a first interpretation in the combined list is a subset of another interpretation.

84. The computer-implemented method of claim 83 wherein combining includes removing the first interpretation from the combined list.
